(19) United States
(12) Patent Application Publication
(10) Pub. No.: US 2007/0195331 A1
(43) Pub. Date: Aug. 23, 2007

(54) Coating thickness gauge

(75) Inventors: Ian Bain, Livingston (GB); Ketil Karstad, Livingston (GB); Stephen Wilson, Livingston (GB); David Hamilton, Livingston (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Scalar Technologies Limited, Livingston (GB)

(21) Appl. No.: 11/548,817

(22) Filed: Oct. 12, 2006

(30) Foreign Application Priority Data
Dec. 8, 2005 (GB) 0525021.2

(51) Int. Cl. G01B 11/02; G01B 21/08; G01B 11/28; G01D 21/00

(52) U.S. Cl. 356/503; 73/150 R; 73/866.5; 356/630; 356/497

(57) ABSTRACT

A coating thickness gauge for measuring the thickness of a coating on a surface of a can is described. The gauge comprises a probe head and a probe head locating mechanism. By employing the probe head locating mechanism the probe head can be easily orientated relative to the surface of a can. The ability to select and fix the measurement orientation of the probe head provides the coating thickness gauge with enhanced flexibility such that it can be employed to take measurements from all surface sections of the can, both interior and exterior. This ability is not dependent on the experience, knowledge or skill of a particular operator. As a result the gauge provides for a fast means of measuring the thickness of a coating which can be used within an in line feedback system, on a commercial scale.

The present invention relates to the field of coating thickness measurement and in particular to a coating thickness gauge suitable for measuring the thickness of coatings located on the surface of a can.

Cans are commonly employed as enclosures within a number of industrial sectors e.g. paint cans, food and drink cans and aerosols cans. It is estimated that around 240 billion cans a year are produced for use within the food and drink industry alone. Presently, these cans, and in particular the internal surfaces, are provided with a coating such as lacquer, a base coat, an oil, a wax or varnish that is generally applied to the surface of the can during the production process.

The external surfaces of these cans also often comprise a protective lacquer coating. The function of these external coatings is primarily to provide a physical protection barrier for the print layer applied directly to the external surface of the can. It is commercially important to the manufacturer of the contents of the cans for the printed layer to remain undamaged. This is because it is this printed layer which carries the various brands of the manufacturer thus it is critical that such a layer provides a high quality visual impact to the relevant trade.

It is also known in the art to apply a separate lacquer coating to the external surface of the rim of a can. The function of this particular coating is to allow for the can to be manipulated by a sliding action during the manufacturing process. If no such coating is present, or if the coating is too thin, then the productivity of the manufacturing process is found to be significantly hindered and more spoiled cans are produced.

For the above reasons it can be seen it is critical that the thickness of the various coatings applied to a can are carefully controlled. For example, with reference to the internal surface coating, if too little coating is applied then corrosion, or other similar forms of can degradation, may occur. As a direct result the material from which the can is produced may contaminate the contents of the can. For example in the food and drink industry the produce contained within tin cans may develop a metallic taste if too little coating is applied to the internal surface of the can.

A solution to the above problems comprises the tendency to over spray the quantity of the coatings during the can production process. However over spraying is an expensive and highly unsatisfactory solution since the coating process quickly becomes unnecessarily expensive thus increasing overall production costs.

In order to mitigate this problem it is known to monitor samples of cans being produced by employing weighing methods. One method involves weighing the can before the application of the coating materials and thereafter reweighing the can after the application and curing processes have taken place. Alternatively, the can may be weighed after application and curing of the coating materials then following removal of the coating, the can is reweighed so as to provide a calculation for the amount of coating present.

Obvious problems exist in connection with the above described methods. One significant problem relates to the fact that the curing process takes approximately fifteen minutes to carry out and therefore, by the time the amount of coating has been determined, many more components within a production line have been coated and are in the process of being cured. Typically in the food and drink industry coating systems typically run in the region of 420,000 per hour and so a great deal of wastage can result if the amount of coating is found to be incorrect. Furthermore, these techniques are limited to monitoring the overall weight of the coating and do not facilitate the calculation of the particular thickness of the coating at individual points within, and around, the can.

FIG. 1 presents a schematic representation of a can 1 typically employed within the food and drink industry. The can 1 comprises a neck section 2 located between a flange 3 and a side wall 4 of the can. Generally, the base of the can is shaped such that it comprises a chine 5 (sometimes referred to as the chime), a well 6, the external surface of which forms the rim 106, a reverse wall 7, a dome ridge 8 and a dome 9. For the reasons outlined above, it is highly beneficial to be able to measure the thickness of coatings located upon the internal and external surfaces of any of these sections. However when the can is formed it can be difficult to gain access so as to facilitate measurement of the various coating thicknesses.

One prior art system that attempts to provide a means for measuring the thickness of a coating within a can 1 is based on a capacitor sensor. The plates of the capacitor sensor are located at the distal end of two capacitor arms such that they can be positioned on opposite sides of the side wall 4 of the can 1 i.e. one capacitor plate being positioned within the can 1 the other being located out with the can 1. Pressure is then applied to the plates such that the coatings act as a dielectric within the capacitor sensor. By obtaining a measurement of the capacitance between the plates a means for calculating the thickness of the coating is achieved.

In practice, it is known that a user can inadvertently affect the measured results of the capacitor sensor. This is especially true where an operator is required to manipulate the probe during testing. It has been shown that a consistent pressure is required to be applied to the plates of the capacitor sensor so as to obtain consistent and repeatable results. This is obviously detrimental to the suitability of capacitor sensors to measuring the coatings on the internal surface of a can. In addition, since capacitor sensors require physical contact with the surfaces from which measurements are to be taken they are limited to what sections of the can 1 measurements can be taken. In practice, capacitor sensors techniques are found to really be suitable for use on flat section of the can 1 e.g. the side wall 4. Thus, capacitor sensors cannot readily be employed to measure the thickness of the coating on the flange 3, neck 2, chine 5, well 6, rim 106, reverse wall 7, or dome ridge 8 sections of the can 1, as shown in FIG. 1.

Furthermore, it will be readily apparent that when taking a measurement from the side wall 4 of the can capacitor sensors are unable to provide information regarding the thickness of an inner and an outer coating. Instead what is provided is a information about the combined thicknesses of these two layers.

It is also found that even on flat surfaces there is a lower practical limit to the thickness of the coatings that can be measured. Thus, readings taken from coatings below these limits are either too unreliable to form the basis for in-line modifications to the manufacturing process or just simply unattainable.

It is therefore an object of the present invention to provide a coating thickness gauge that overcomes one or more of the above outlined deficiencies of the prior art.

### SUMMARY OF INVENTION

According to a first aspect of the present invention there is provided a coating thickness gauge suitable for measuring the thickness of a coating on a surface of a can, the gauge comprising a probe head located at a distal end of a probe arm, the probe arm having a longitudinal axis, and a probe head locating mechanism wherein the probe head locating mechanism provides a means for selecting and fixing a measurement orientation of the probe head relative to the longitudinal axis.

The ability to select and fix the measurement orientation of the probe head, provides the coating thickness gauge with the ability to be employed with a greater number of surfaces sections of the can to be tested, and in particular with a greater number of the internal sections of the can. Most significantly this ability is not dependent on the experience, knowledge or skill of a particular operator.

Most preferably the coating thickness gauge further comprises an electromagnetic wave source suitable for producing an interference pattern following reflection of the electromagnetic waves from the coating on the surface of the can.

The source of electromagnetic waves may comprise a white light source such as a halogen lamp or a monochromatic light source such as a laser or a light emitting diode.

Preferably the coating thickness gauge further comprises an optical fibre employed to couple the electromagnetic wave source to the probe head.

Employing the optical fibre allows for the electromagnetic wave source to be positioned away from the probe head and even provided as a separate modular unit.

Alternatively the electromagnetic wave source is located within the probe head.

Most preferably the optical fibre is also arranged to couple the electromagnetic waves following their reflection from the coating. Unless beam steering elements are employed this arrangement generally requires the optical fibre to be substantially perpendicular to the coating, the thickness of which is required to be measured.

Most preferably the optical fibre comprises a bifurcated optical fibre.

Optionally the probe head further comprises one or more beam steering elements employed to shape and redirect the electromagnetic waves.

Preferably the coating thickness gauge further comprises a spectrometer arranged to receive the reflected electromagnetic waves.

Most preferably the probe head locating mechanism comprises a ledge suitable for receiving the can comprising the coating to be tested.

Preferably the probe head locating mechanism further comprises two rollers connected to one or more roller electric motors wherein the operation of the one or more roller electric motors results in the rollers rotating with the same orientation.

Preferably the roller electric motor is connected to the two rollers via a first belt located around at least two belt cogs located on a first roller support.

Alternatively, the probe head locating mechanism further comprises a turn table the rotation of which is controlled by a turn table electric motor.

Preferably the turn table electric motor is connected to the turn table via a turn table belt.

Most preferably the turn table further comprises three or more arms mounted upon a first surface of the turn table wherein the three or more arms are resiliently biased towards a centre of the first surface of the turn table. Such an arrangement allows the can to be secured upon the first surface of the turn table when required for testing.

Preferably each of the arms are pivotally mounted upon the first surface of the turn table.

Most preferably the turn table further comprises a gearing mechanism arranged such that each of the three or more arms rotate with the same orientation and magnitude.

In a further alternative, the probe head locating mechanism comprises a first probe electric motor connected to the probe arm wherein the operation of the first probe electric motor results in the probe arm rotating about the longitudinal axis. All of the above arrangements provide a means for introducing a relative rotational movement between the probe head and a can to be tested by the gauge.

Preferably the probe head locating mechanism further comprises a probe arm support that connects the probe arm to a mount.

Preferably the probe head locating mechanism further comprises one or more support rods the length of which is substantially parallel to the longitudinal axis and upon which the mount is located.

Most preferably the probe head locating mechanism further comprises a second probe electric motor connected to the mount wherein the operation of the second probe electric motor controls the position of the probe head along the longitudinal axis.

Preferably at least one of the support rods is threaded and the second probe electric motor is connected to the mount via a gear mechanism.

Most preferably the probe head locating mechanism further comprises a third probe electric motor connected to the probe arm support wherein the operation of the third probe electric motor controls the position of the probe head along an axis perpendicular to the longitudinal axis.

Preferably the third probe electric motor is connected to the probe arm support via a second belt located around at least two belt cogs located on the mount.

Most preferably the probe head locating mechanism further comprises a fourth probe electric motor connected to the probe head wherein the operation of the fourth probe electric motor controls the angle of the probe head relative to the longitudinal axis.

Preferably the fourth probe electric motor is connected to the probe head via a third belt located around at least two belt cogs located on the probe arm.

Preferably the spectrometer is arranged to receive the electromagnet waves coupled into the optical fibre.

Most preferably the coating thickness gauge further comprises an electronic controller employed to automatically control the electric motors of the probe head locating mechanism. The electronic controller may comprise an electronic controller selected from a group comprising a computer, a computer processing unit (CPU), an application-specific integrated circuit (ASIC) and a field programmable gate array (FPGA).

Preferably the electronic controller is also employed to automatically control the spectrometer.

### BRIEF DESCRIPTION OF DRAWINGS

Aspects and advantages of the present invention will become apparent upon reading the following detailed description and upon reference to the following drawings in which:

FIG. 1 presents a schematic representation of one type of beverage can;

FIG. 2 presents a perspective view of the coating thickness gauge in accordance with an aspect of the present invention;

FIG. 3 presents a perspective view of a right angled triangular frame and a probe locating mechanism of the coating thickness gauge of FIG. 2;

FIG. 4 presents (a) a perspective view of the probe locating mechanism of FIG. 3; and (b) an alternative embodiment of the probe locating mechanism;

FIG. 5 presents a schematic representation of the coating thickness gauge of FIG. 2;

FIG. 6 presents a perspective view of the probe head of the apparatus of FIG. 2;

FIG. 7 presents an illustration of the interaction of white light with a coating to be tested with the thickness gauge;

FIG. 8 presents a schematic representation of an alternative embodiment of the coating thickness gauge; and

FIG. 9 presents (a) a side view, and (b) a plan view, of a turn table mechanism of the coating thickness gauge of FIG. 8.

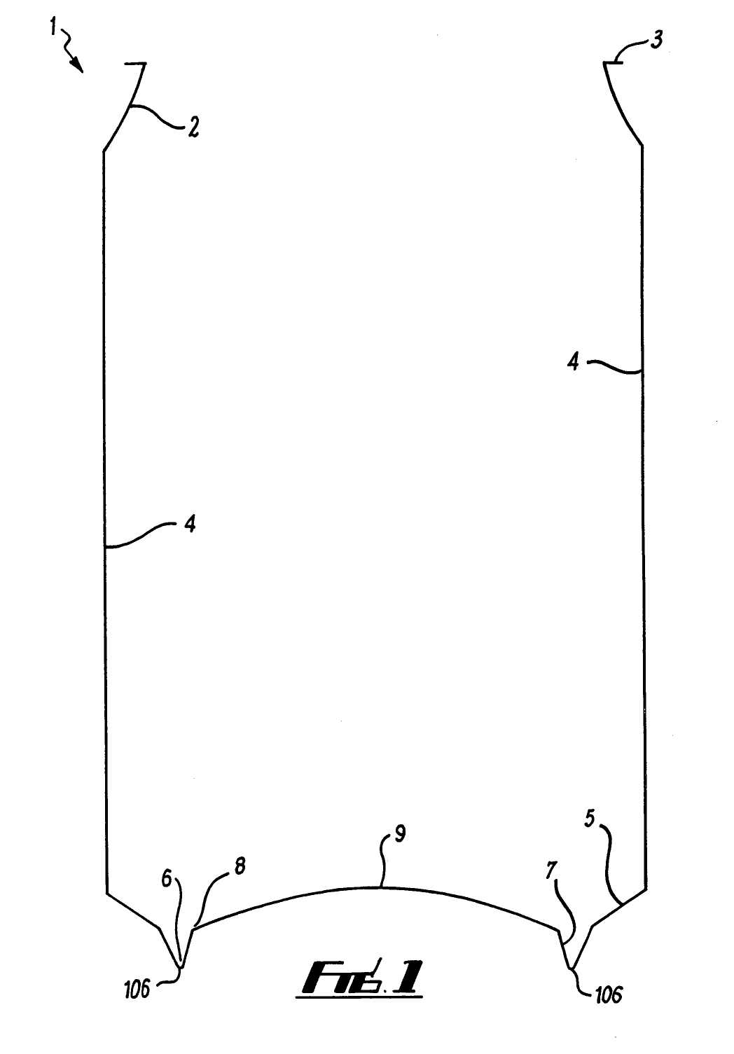

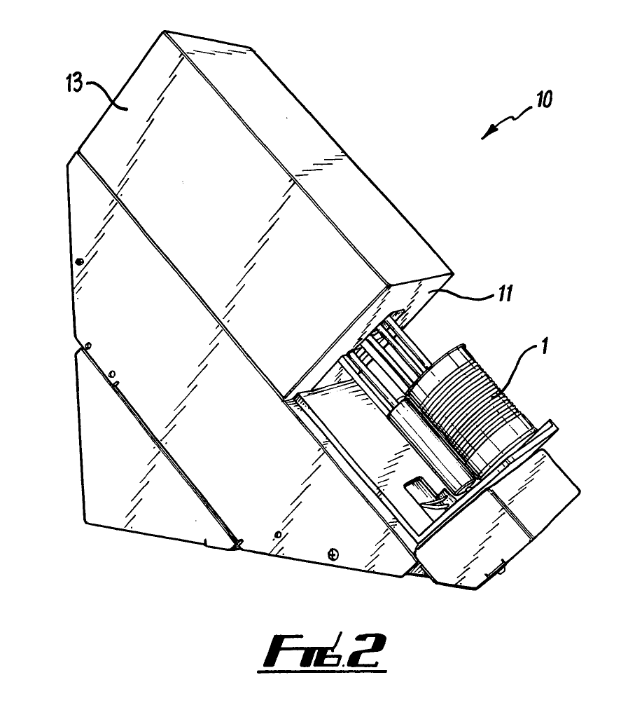

### DETAILED DESCRIPTION

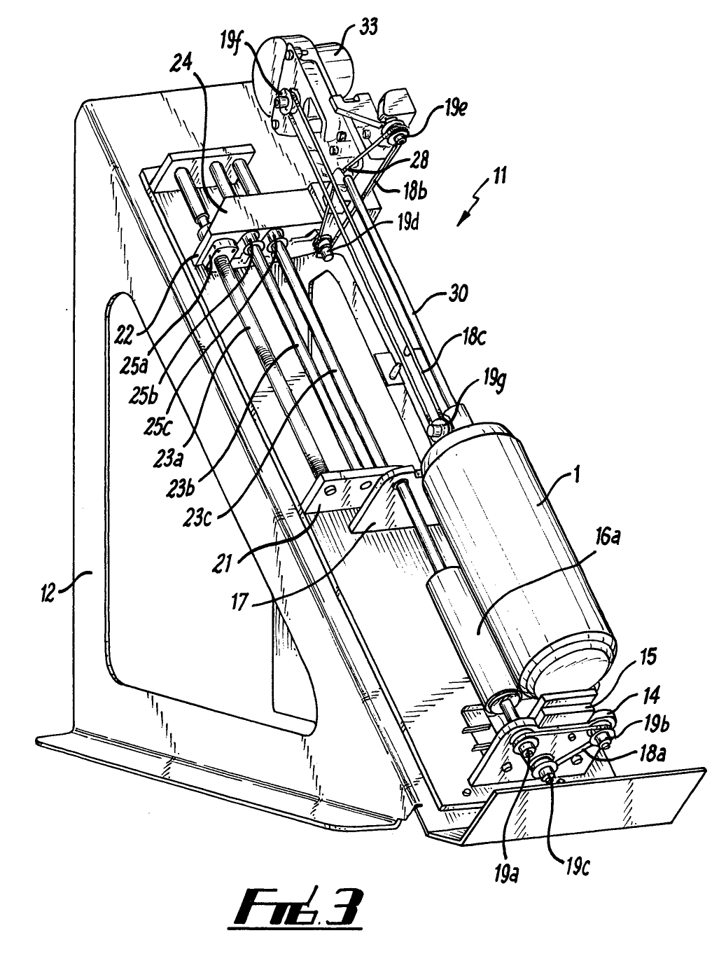

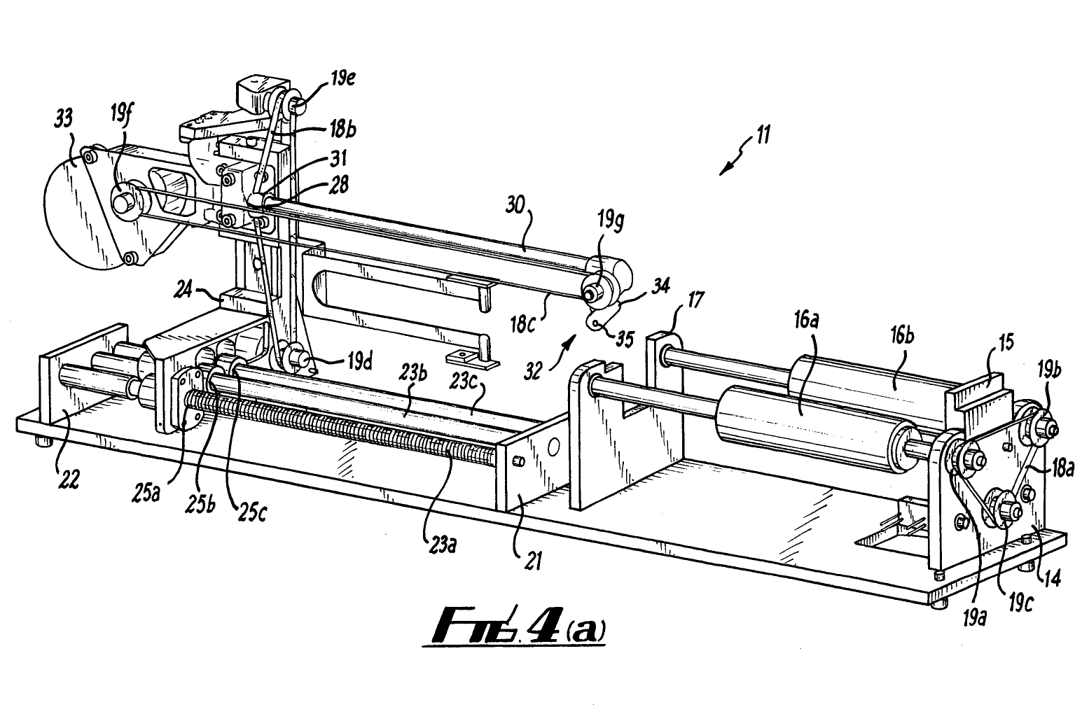

In order to assist understanding of various aspects of the present invention, FIG. 2 presents a perspective view of a coating thickness gauge 10. The coating thickness gauge 10 can be seen to comprise a probe locating mechanism 11 that is positioned upon the hypotenuse side of a right-angled triangular frame 12, (see FIG. 3). The can 1 to be tested by the coating thickness gauge 10 is also present in both FIGS. 2 and 3. Plate sections 13 act as a physical barrier so as to protect the internal components of the gauge 10.

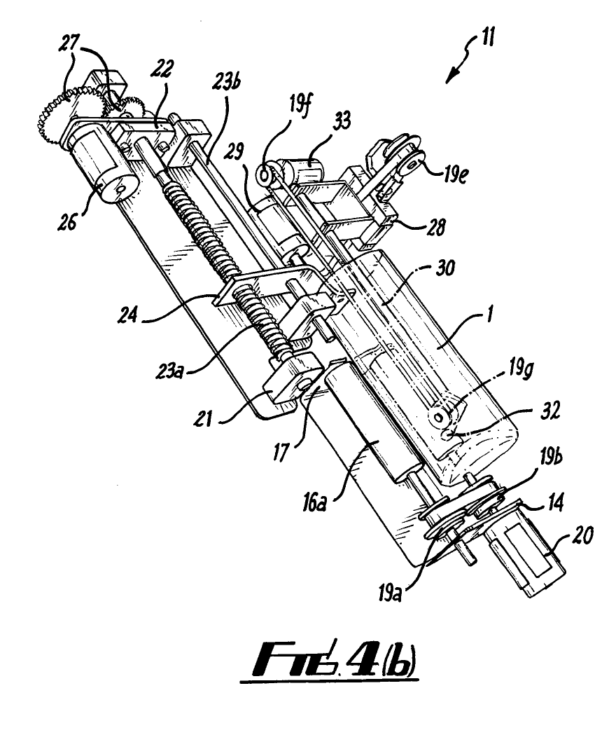

Further detail of the probe locating mechanism 11 can be seen within FIG. 4. It should be noted that for clarity purposes some of the electric motors (discussed below) have been removed from the views of the probe locating mechanism 11 presented in FIG. 3 and FIG. 4(a). Furthermore, FIG. 4(b) presents an alternative embodiment of the probe locating mechanism 11 that employs electric motors of a different design.

At one end of probe locating mechanism 11 is located a first roller support 14 upon which is positioned a ledge 15. The ledge 15 is employed so as to allow for the can 1 to be properly orientated within the gauge 10. In a preferred embodiment the ledge 15 is shaped so as to be suitable for locating on the rim 106 or the dome 9 of the can 1.

Two rollers 16a and 16b extend longitudinally along the probe locating mechanism 11 between the first roller support 14 and a second roller support 17. The rotation of the rollers 16a and 16b is controlled by means of a first belt 18a, located around three belt cogs 19a, 19b and 19c, positioned on the first roller support 14. The first belt 18a comprises a plurality of teeth on its inner surface that interact with a plurality of teeth located on the external surface of the three belt cogs 19a, 19b and 19c. It is the interaction of these teeth that prevents the first belt 18a slipping relative to the three belt cogs 19a, 19b and 19c.

It should be noted that the rollers 16a and 16b can equally well be controlled in a similar manner by the interaction of the first belt 18a and two belt cogs, namely belt cogs 19a and 19b as shown in FIG. 4(b). In a similar manner alternative embodiments may employ more than three belt cogs.

A first electric motor 20 is connected to the first belt 18a via belt cog 19b that is also connected directly to roller 16b. Belt cog 19a is connected directly to roller 16a. Thus, when the first electric motor 20 is activated, the belt cog 19b is caused to rotate which in turn causes the first belt 18a, roller 16b, belt cogs 19a 19c and roller 16a to all rotate with the same orientation. Since the rollers 16a and 16b rotate with the same orientation, the can 1 positioned on the ledge 15 and resting against the rollers 16a and 16b is rotated with the opposite sense to that of the rollers 16a and 16b.

The probe locating mechanism 11 further comprises first 21 and second rod support plates 22. Located between plates 21 and 22 are three support rods 23a, 23b and 23c. Support rod 23a can be seen to be threaded while support rods 23b and 23c are of a non-threaded type. It should be noted that the number of non threaded support rods is not critical to the operation of the probe locating mechanism 11, indeed the probe locating mechanism 11 presented in FIG. 4(b) comprises only a single non-threaded support rod 23b.

An L-shaped mount 24 is located between plates 21 and 22 such that the support rods 23a, 23b and 23c extend through rod apertures 25a, 25b and 25c located on a first arm of the L-shaped mount 24. The longitudinal position of the L-shaped mount 24 on the rods 25a, 25b and 25c is controlled by the interaction of a second electric motor 26 and a gear mechanism 27 located at one end of the threaded support rod 23. Thus, when the second electric motor 26 is activated it drives the gear mechanism 27 and causes the threaded support rod 23a to rotate. Rotation of the threaded support rod 23a causes the L-shaped mount 24 to be translated along the length of the support rods 25a, 25b and 25c, the direction of translation being dependent on the orientation or the rotation of the threaded support rod 25a.

Located on the second arm of the L-shaped mount 24 is a probe arm support 28, two belt cogs 19d and 19e over which is arranged a second belt 18b. The second belt 18b comprises a plurality of teeth on its inner surface that interact with a plurality of teeth located on the external surface of the two belt cogs 19d and 19e and with a section of teeth located on the probe arm support 28. It is the interaction of these teeth that prevents the second belt 18b slipping relative to the two belt cogs 19d and 19e and the probe arm support 28.

A third electric motor 29 is connected to the second belt 18b via belt cog 19d. When activated the third electric motor 29 drives the belt cog 19d which in turn causes the second belt 18b, and hence belt cog 19d, to rotate with the same orientation. Thus, the longitudinal position of the probe arm support 28 along the second arm of the L-shaped mount 24 is controlled by the operation of the third electric motor 29.

A probe arm 30 extends through a probe arm aperture 31 located on the probe arm support 28, the length of which defines a probe axis. Located at the distal end of the probe arm 30 is a probe head 32 that is connected to a third belt 18c. The position of the probe head 33 relative to the probe arm 30 is controlled by the interaction of the third belt 18b, that is looped over belt cogs 19f and 19g. A fourth electric motor 33 is connected to the third belt 18c via belt cog 19f. When activated the fourth electric motor 33 drives the belt cog 19f which in turn causes the third belt 18c, and hence belt cog 19g, to all rotate with the same orientation.

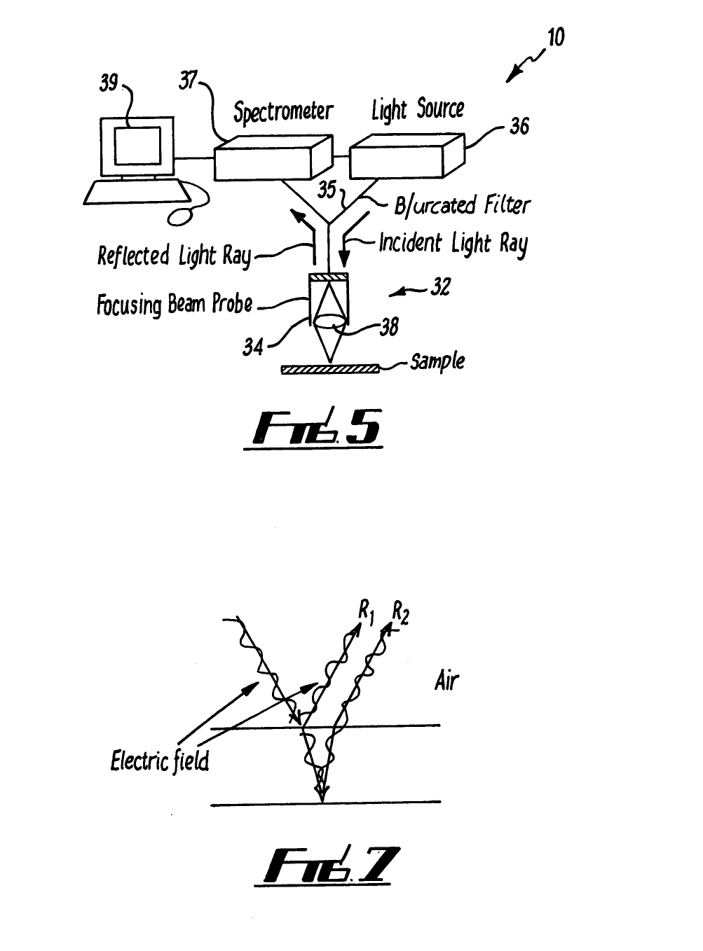

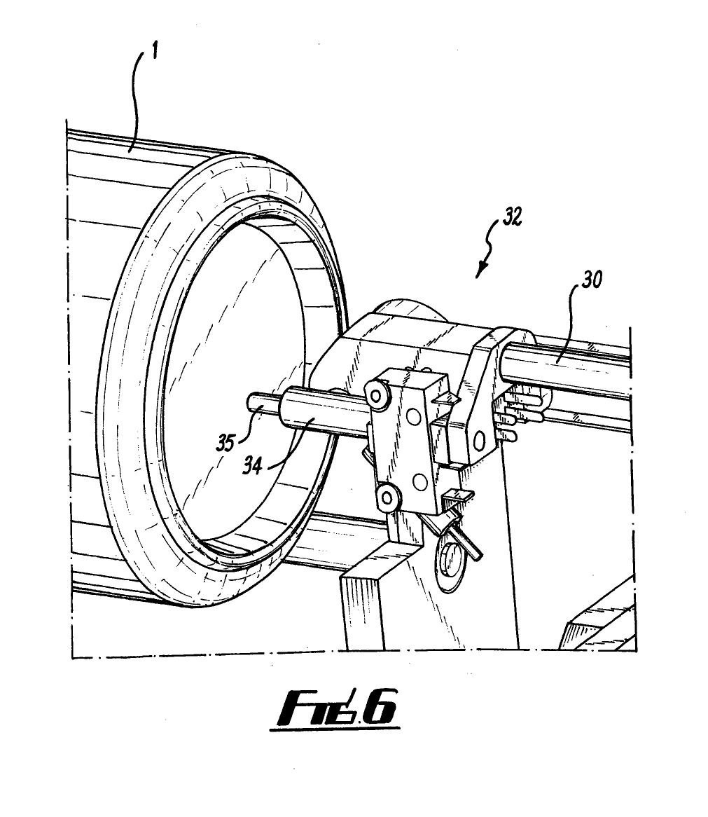

Further detail of the probe head 32 can be seen from FIG. 5 and from FIG. 6, that presents a schematic representation of the operation of the coating thickness gauge 10. The probe head 32 comprises a probe casing 34 within which is housed a distal end of a bifurcated optical fibre 35. White light from a halogen lamp 36, located below the right-angled triangular frame 12, is coupled into the bifurcated optical fibre 35 and so propagates to the probe head 32. In the presently described embodiment, the bifurcated optical fibre 35 comprises six outer fibres, that are employed to deliver the white light to the coating area to be tested, and an inner fibre that collects the reflected light for analysis in a spectrometer 37, this being a Zeiss MCS spectrometer in the presently described embodiment.

Depending on the precise form of the optical fibre 35 and the light source employed beam steering optics may be employed within the coating thickness gauge 10. For example, a focusing or collimating lens 38 may optionally be housed within the probe casing 34. In a further alternative embodiment of the probe head (not explicitly shown) the light source employed may itself be housed within the probe casing 34 so removing the requirement for the employment of the optical fibre 35. Beam steering elements such as lenses and mirrors are then employed so as to shape and redirect the light produced by the light source towards the can 1 and thereafter to shape and redirect the reflected light from the coating to the spectrometer 37.

The probe locating mechanism 11 further comprises a an electronic controller in the form of a computer 39 that is employed to automate the control of the electric motors 20, 26, 29 and 33, as described in further detail below. The computer is also employed to control the spectrometer 37 and to process the data recorded by the spectrometer.

The coating thickness gauge 10 operates in the following manner. The can 1 to be tested is initially located on the rollers 16a and 16b and ledge 15. Thereafter the controlled use of the electric motors 20, 26, 29 and 33 allows for the position of the probe head 32 to be moved to the required measurement taking position within, or around, the can 1. The first electric motor 20 allows for rotation of the can 1 relative to the probe axis; the second electric motor controls the movement of the probe head 32 along the probe axis; the third electric motor controls the movement of the probe head 32 along an axis perpendicular to the probe axis; and the fourth electric motor controls the angle of the probe head 32 relative to the probe axis. Thus, the combination of the four electric motors 20, 26, 29 and 33 is used to locate the probe head 32 at any position within, or around, the can 1 so as to allow for testing of the inner or outer surface coatings.

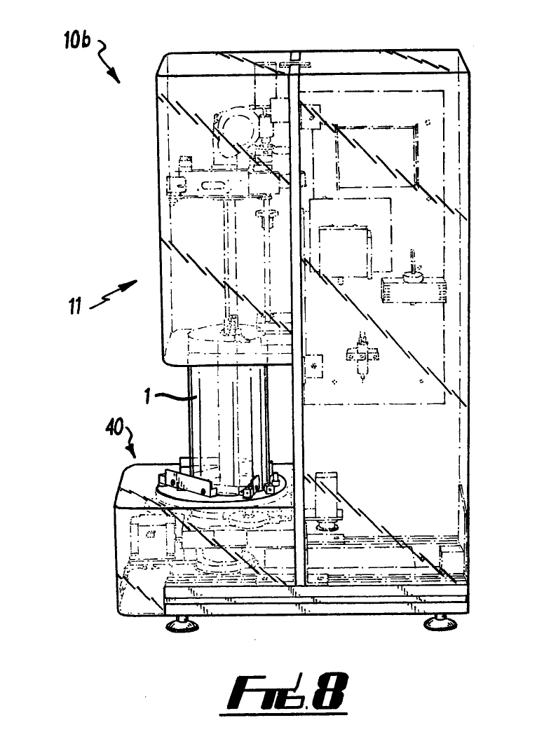

For example, the thickness of the coating on the internal surface of the can 1 is measured by employing white light interferometry techniques. When the white light provided by the halogen lamp 36 is reflected from the coating, a spectrum of light is produced that is dependent on the optical properties of the coating (i.e. absorption co-efficient, refractive index and thickness). In particular, when the probe head 32 is located near to the sample of the coating to be tested, a reflective signal is obtained from the first and second surfaces upon which the white light is incident. FIG. 7 illustrates this effect diagrammatically. For a given material of a certain thickness, the reflected signals produce a spectrum that carries interference modulations, the thicker the coating the greater the number of modulations produced within the spectrum. Since the refractive index n and the co-efficient absorption of the coating can be predetermined, or accounted for by reference to a calibrated sample, then by counting the number of interference modulations within the reflected optical response and comparing these to known or modelled predictions provides a means for accurately measuring the thickness of the coating on the inner surface of the can 1. As an alternative to the fringe counting techniques described above, curve fitting methods to the captured data may be also be employed.

It should be noted that the only restriction on the position within the can 1 at which the measurement is taken resides in the fact that the probe head 32 must be orientated such that the optical fibre 35 is substantially perpendicular to the coating area to be tested. However, the employment of the probe locating mechanism 11 provides a means for allowing this criterion to be met since the probe head 32 can be orientated and fixed over 4π steradians. Thus the coating thickness gauge 10 can be readily employed to measure the thickness of the inner and outer coatings on the flange 3, neck 2, chine 5, well 6, reverse wall 7, dome ridge 8 or dome 9 sections of the can 1.

It will be readily apparent that alternative driving mechanisms may be employed within the coating thickness gauge 10 in order to provide the required positioning of the probe head 32 at the internal or external surfaces of the can 1 to be tested. For example, in place of the two rollers 16a and 16b used to rotate the can 1 relative to the probe head 32, an alternative embodiment may employ an electric motor to rotate the probe arm 30 so as to achieve the required relative movement between the probe head 32 and the can 1.

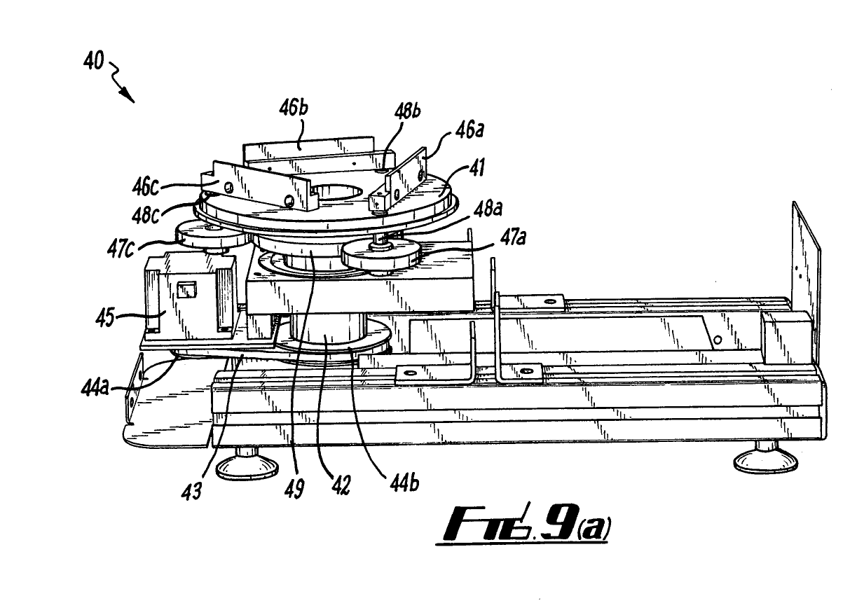

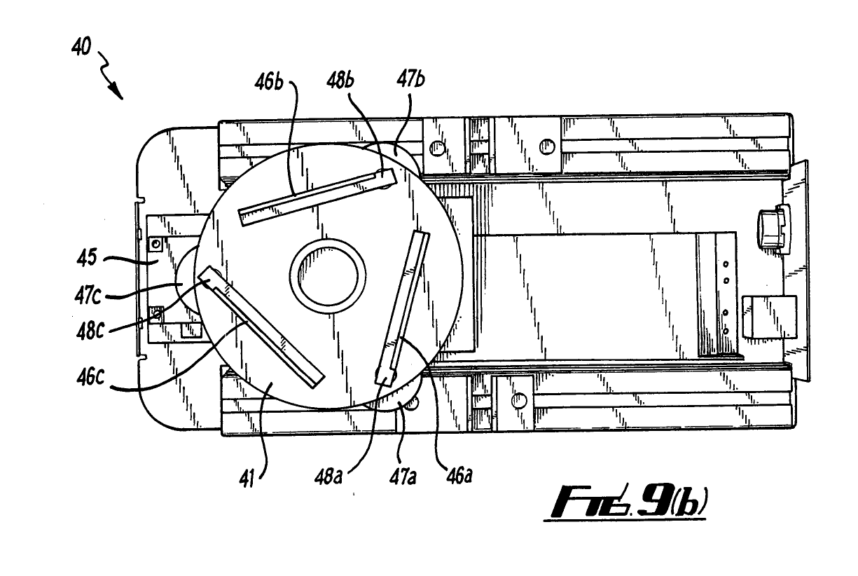

By way of further example, FIG. 8 presents a schematic representation of an alternative embodiment of the coating thickness gauge 10b. In this embodiment rotation of the can 1 is achieved through the employment of a turn table mechanism 40, as shown in further detail within FIG. 9, instead of the driven roller mechanism of the previously described embodiments. The turn table mechanism 40 can be seen to comprise a circular table 41 connected to one end of a table drive shaft 42. Rotation of the table drive shaft 42, and hence the circular table 41 itself, is controlled by means of a table drive belt 43. The drive belt is located around two table cogs 44a and 44b. As can be seen from FIG. 9, the first table cog 44a is attached to an electric stepper motor 45 while the second table cog 44b is attached to the opposite end of the table drive shaft 42 from the circular table 41. The table drive belt 43 comprises a plurality of teeth on its inner surface that interact with a plurality of teeth located on the external surfaces of the two table cogs 44a and 44b. It is the interaction of these teeth that prevents the table drive belt 43 slipping relative to the two table cogs 44a and 44b.

Three pivoting arms 46a, 46b and 46c located on top of the table 41 allow for a can 1 to be secured in position for testing. One end of each of the pivoting arms 46a, 46b and 46c is connected to a corresponding orbital gear wheel 47a, 47b and 47c by means of respective pins 48a, 48b and 48c. Each of the orbital gear wheels, 47a, 47b and 47c, is in mechanical communication with a central gear wheel 49 due to the presence of interlocking teeth located around the perimeter's of all of these wheels. As a result of this arrangement rotational movement of one of the pivoting arms e.g. 46a results in a mirrored rotational movement of the other two arms i.e. 46b or 46c.

In addition, orbital gear wheel 47a is also resiliently biased in an anti clockwise manner such that, due to the presence of the gearing mechanism, all three of the pivoting arms 46a, 46b and 46c tend towards a closed position, as shown in FIG. 9.

To secure a can 1 on the table 41 it is simply required to manually pivot one of the pivoting arms 46a, 46b or 46c away from its closed position since a rotational movement of one arm is mirrored by the rotation of other two pivoting arms. Once the pivoting arms 46a, 46b and 46c have rotated far enough to provide clearance for the base of the can 1 it is then place on top of the table 41. Releasing the manually pivoted arm results in all three of the pivoting arms 46a, 46b and 46c arms rotating back towards the closed position. Thus, pivoting arms 46a, 46b and 46c act to secure the can 1 on the table by clamping the can 1 around the perimeter of its base.

Clamping of the can 1 in this manner has the advantage of reducing the detrimental effects of can slippage, as experienced when employing the driven roller mechanism with some forms of can 1. A further advantage of the turn table mechanism 40 over the previously described driven roller mechanism is the fact that the employment of the pivoting arms 46a, 46b and 46c acts to always centre a can 1 upon the table 41. Thus, when taken in combination with the clamping function of the pivoting arms 46a, 46b and 46c it is found that results produced by the coating thickness gauge 10b have increased repeatability, and thus the reliability, over those recorded by employing coating thickness gauge 10.

It should be noted that the above described apparatus and techniques are not limited to metal cans, but can be readily extended to any enclosure made from alternative materials, such as glass or plastic, and which employ a substantially transparent coating. All that is required is that a reflected signal is produced that comprises a spectrum that carries interference modulations. Thus although white light interferometry has been described in detail it will be readily apparent to those skilled in the art that alternative electromagnetic wave sources may equally well be employed, with or without an optical fibre, as long as they can be coupled from the probe head to the coating, and following reflection, to the spectrometer. For example monochromatic light sources such as LED's or diode lasers may equally well be employed as these would produce similar interference patterns the characteristics of which would be indicative of the thickness of the coating.

The flexibility of the light source employed by the gauge 10 can be seen when considering the deployment of the device to measure the external coating of a can 1. In practice it is found that the colouring within the printed layers affects the reliability of interferometer techniques that employ light from the visible range of the electromagnetic spectrum. When taking measurements from these surfaces it has been found to be most beneficial to employ light within the infra red range of the electromagnetic spectrum. Importantly however, this does not require the employment of a separate IR light source since the levels of IR radiation generated by the halogen lamp 36 are found to be more than sufficient for this purpose.

The optical fibre described above is a bifurcated optical fibre. It will be readily apparent that a number of different fibre configurations may be employed. Example alternatives include a number of single core fibres; two separate fibres, one to carry the light to the sample the other for coupling the reflected light; or a single fibre core provided that reflected light coupled back into the fibre can be separated from the input light field. However these alternative embodiments would generally increase the probe head size and/or reduce the coupling efficiency for the reflected signals.

It will also be appreciated by those skilled in the art that various modular elements of the coating thickness gauge 10, namely the light source, the computer and the spectrometer, may be fully incorporated within the device or one or more of these elements may be provided as separate elements connected, as appropriate, to the probe locating mechanism 11.

The probe locating mechanism 11 may be employed with an alternative probe head in order to carry out measurements of the thickness of a coating. For example the presently describe probe head 32 could be replaced by an automated micrometer or even a capacitor sensor although some of the above mentioned limitations of such systems would still exist.

A particularly significant advantage of the described coating thickness gauge 10 is that, unlike the capacitor sensor devices, it is not limited to use on substantially flat surfaces or by any lower limit of the thickness of the coatings that can be measured. Thus the device is significantly more flexible in its deployment than those systems described in the prior art. For example, cans 1 employed within the food and drinks industry typically comprise corrugated sections along the side wall 4 that are highly problematic for the prior art systems. However, the thickness of the coatings at these areas may be tested in a similar manner to that described above by the coating thickness gauge 10. As a result accurate thickness testing may be carried out which results in a significant reduction in consumption of coating material since over spraying techniques are no longer required to be employed.

Further commercial advantages of the present apparatus over that known in the art result from the fact that the gauge 10 provides an optical non-contact measurement of a can that is non-destructive to the particular can under test. As a result the gauge provides for a fast means of measuring the thickness of the coating on the inside and outside of the can which can be used within an in line feedback system, on a commercial scale. As a consequence, greater product quality can be achieved since accurate readings also mean that the coating or spray equipment can be monitored more closely to the required specification. In addition problems and detrimental trends can be spotted earlier in the manufacturing process thus reducing the quantity of bad products made.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1) A coating thickness gauge suitable for measuring the thickness of a coating on a surface of a can, the gauge comprising a probe head located at a distal end of a probe arm, the probe arm having a longitudinal axis, and a probe head locating mechanism wherein the probe head locating mechanism provides a means for selecting and fixing a measurement orientation of the probe head relative to the longitudinal axis.

2) A coating thickness gauge as claimed in claim 1 wherein the gauge further comprises an electromagnetic wave source suitable for producing an interference pattern following reflection of the electromagnetic waves from the coating on the surface of the can.

3) A coating thickness gauge as claimed in claim 2 wherein the source of electromagnetic waves comprises a white light source.

4) A coating thickness gauge as claimed in claim 2 wherein the source of electromagnetic waves comprises a monochromatic light source.

5) A coating thickness gauge as claimed in claim 2 wherein the gauge further comprises an optical fibre employed to couple the electromagnetic wave source to the probe head.

6) A coating thickness gauge as claimed in claim 5 wherein the optical fibre is also arranged to couple the electromagnetic waves following their reflection from the coating.

7) A coating thickness gauge as claimed in claims 5 wherein the optical fibre comprises a bifurcated optical fibre.

8) A coating thickness gauge as claimed in claims 2 wherein the probe head further comprises one or more beam steering elements employed to shape and redirect the electromagnetic waves.

9) A coating thickness gauge as claimed in claim 2 wherein the gauge further comprises a spectrometer arranged to receive the reflected electromagnetic waves.

10) A coating thickness gauge as claimed in claim 1 wherein the probe head locating mechanism comprises a ledge suitable for receiving the can comprising the coating to be tested.

11) A coating thickness gauge as claimed claim 10 wherein the probe head locating mechanism further comprises two rollers connected to one or more roller electric motors wherein the operation of the one or more roller electric motors results in the rollers rotating with the same orientation.

12) A coating thickness gauge as claimed in claims 11 wherein the roller electric motor is connected to the two rollers via a first belt located around at least two belt cogs located on a first roller support.

13) A coating thickness gauge as claimed in claims 1 wherein the probe head locating mechanism comprises a turn table the rotation of which is controlled by a turn table electric motor.

14) A coating thickness gauge as claimed in claims 13 wherein the turn table electric motor is connected to the turn table via a turn table belt.

15) A coating thickness gauge as claimed in claim 13 wherein the turn table further comprises three or more arms mounted upon a first surface of the turn table wherein the three or more arms are resiliently biased towards a centre of the first surface of the turn table.

16) A coating thickness gauge as claimed in claim 15 wherein each of the arms are pivotally mounted upon the first surface of the turn table.

17) A coating thickness gauge as claimed in claim 16 wherein the turn table further comprises a gearing mechanism arranged such that each of the three or more arms rotate with the same orientation and magnitude.

18) A coating thickness gauge as claimed in claim 1 wherein the probe head locating mechanism comprises a first probe electric motor connected to the probe arm wherein the operation of the first probe electric motor results in the probe arm rotating about the longitudinal axis.

19) A coating thickness gauge as claimed in claim 1 wherein the probe head locating mechanism further comprises a probe arm support that connects the probe arm to a mount.

20) A coating thickness gauge as claimed claim 19 wherein the probe head locating mechanism further comprises one or more support rods, the length of which is substantially parallel to the longitudinal axis, and upon which the mount is located.

21) A coating thickness gauge as claimed in claim 20 wherein the probe head locating mechanism further comprises a second probe electric motor connected to the mount wherein the operation of the second probe electric motor controls the position of the probe head along the longitudinal axis.

22) A coating thickness gauge as claimed in claim 21 wherein at least one of the support rods is threaded and the second probe electric motor is connected to the mount via a gear mechanism.

23) A coating thickness gauge as claimed in claim 19 wherein the probe head locating mechanism further comprises a third probe electric motor connected to the probe arm support such that the operation of the third probe electric motor controls the position of the probe head along an axis perpendicular to the longitudinal axis.

24) A coating thickness gauge as claimed in claim 23 wherein the third probe electric motor is connected to the probe arm support via a second belt located around at least two belt cogs located on the mount.

25) A coating thickness gauge as claimed in claim 19 wherein the probe head locating mechanism further comprises a fourth probe electric motor connected to the probe head wherein the operation of the fourth probe electric motor controls the angle of the probe head relative to the longitudinal axis.

26) A coating thickness gauge as claimed in claim 25 wherein the fourth probe electric motor is connected to the probe head via a third belt located around at least two belt cogs located on the probe arm.

28) A coating thickness gauge as claimed in claim 11 wherein the coating thickness gauge further comprises an electronic controller employed to automatically control the electric motors of the probe head locating mechanism.

29) A coating thickness gauge as claimed in claim 28 wherein the electronic controller is also employed to automatically control the spectrometer.
